(19) United States
(12) Patent Application Publication
(10) Pub. No.: US 2012/0229718 A1
(43) Pub. Date: Sep. 13, 2012

(54) Direct-view adjustable lenticular 3D device and manufacturing process

(76) Inventors: Yinkuei Huang, (US); Kuo Tai Tsai, Pingtung County (TW); Yao-Dong Ma, Frisco, TX (US); Chiung-Sen Lu, Kaohsung (TW)

(21) Appl. No.: 12/932,905

(22) Filed: Mar. 9, 2011

(51) Int. Cl. G02F 1/1335; B32B 37/02; G02B 27/22

(52) U.S. Cl. 349/15; 156/285

(57) ABSTRACT

The preset invention relates to a three-dimensional LCD, and more specifically to a rigid lenticular three dimensional LCD with an air layer and spacer structure which allows realignment and readjustment of the coordination of the lenticular film relative to the display panel so that the 3D effect can be micro-controllable when it is needed to display 3D video images and moving pictures.

### FIELD OF THE INVENTION

The present invention relates to a three-dimensional LCD, and more specifically to a rigid lenticular three dimensional LCD with an air layer and spacer structure which allows realignment and readjustment of the coordination of the lenticular film relative to the display panel so that the 3D effect can be micro-controllable when it is needed to display 3D video images and moving pictures.

### BACKGROUND OF THE INVENTION

In the information age, it is desirable that LCD is capable of displaying stereographic contents or three-dimensional (3D) images. 3D TVs or monitors are becoming more and more popular for not only entertainment purposes, but also as tools in such diverse fields as medicine, manufacturing, security and service/repair. So far, there are two major technologies to display the 3D images. The first is the “3D glasses” methods including both electric addressable LCD glass shutter and polarizer/filter shutter. During the conversion from 2D to 3D, the display will divide even and odd lines of it into two pictures and human left and right eyes can catch them individually by using head mount eye shutters then mix them into a 3D image, a picture moves out of the screen.

In U.S. Pat. No. 6,020,941, one of the applicants introduces a 3D display using the intrinsic properties of the cholesteric liquid crystal material, which has predetermined handedness or polarities such as left-handed or right-handed circular polarity. The display panel consists of two different CLC materials with different chirality; the regions of left-hand circular polarity can be used to display a first image simultaneously with the display of a second image suing the regions of right-hand circular polarity. An observer can sue, for example, a pair of eyeglasses having left and right polarizing lenses corresponding to the polarities of the first and second image to see the stereographic image composed of the first and second images.

There are, however, problems with the “3D glasses” method. One problem is that the viewer must wear the special glass. Another is that many viewers become nauseated due to visual distortions when viewing the picture.

The second is an autostereoscopic method or glasses-less method including lenticular structure and micro barrier structure positioning in the frond of the display panel. Autostereoscopic displays are able to provide binocular depth perception without using headgear or filter/shutter glasses. The technology has existed for many years, and has been used to provide stereoscopic vision in research environments since the 1980s. Such display fools the brain so that a 2D medium can display a 3D image by providing a stereo parallax view for the user. This means that each eye sees a different image, having been calculated to appear from two eye positions. The lenticular lens method typically interlaces different images or viewing angles of a single image, using a raster type interlacing, and then places a sheet formed of a plurality of elongated strip lenses, or lenticules, over the raster image. The structure is such that each lenticule or lens overlays raster lines. The lenticules are formed such that one image is presented to the viewer's left eye and another image is presented to the viewer's right eye.

U.S. Pat. No. 7,336,326 teaches a 3D image display in which 2D and 3D images are interchangeable. The display includes an image display panel which displays 2D or 3D images, and an optical plate which is provided behind the image display panel and refracts an incident light to the image display panel. Also, the 3D image display includes a first flat display device which displays a multi-viewpoint image in a case where the 3D image is displayed, and is transparent in a case where the 2D image is displayed.

U.S. Pat. No. 7,660,041 teaches a method of manufacturing a lenticular sheet having as its primary steps the provision of a substantially transparent substrate material; forming a plurality of lenses on a first side of the substrates; and shaping the substrates to correspond to a display area of a display device, wherein the plurality of lenses are angled to correspond to the pixel size and pitch of the display area. The manufacture relates to produce the lenticular film and to position the same film on the display panel. A polyacrylic micro lens is manufactured on the top side of the polyester film and a PSA adhesive layer deposited in the bottom side of the film which is finally attached to the front side of the TFT panel.

U.S. Patent Application 2007/0040778 teaches a display device for displaying a three dimensional image such that different views are displayed according to the viewing angle has a display panel with a plurality of separately addressable pixels for displaying the image. The pixels are grouped such that different pixels in a group correspond to different views of the image. A display driver controls a transmission characteristic of each pixel to generate an image according to received image data. The display introduces a reverse mode lenticular structure which faces to the display panel.

U.S. Patent Application 2007/0268589 teaches a compensation means for lens alignment errors and viewing location change in 3D monitor. It relates to a method for multiplexing an optimal 3D image, by detecting inhomogeneity and alignment error of lens in a lenticular 3D LCD monitor, minimizing the image distortion caused by the detected error, and considering the viewer's position.

However, the above-mentioned lenticular 3D display has the following disadvantages.
1. The current lenticular 3D LCDs are utilizing a flexible lenticular film laminated permanently on the display panel by means of a pressure adhesive layer after an initial registration during the manufacturing process. Once the film has attached on the front surface of the display it is impossible to fine-tuning the 3D effect for achieving the maximum accuracy. Misalignment is the major problem of the products.
2. Multiple lenticular films positioning on the LCD panel is capable of converting of 2D image to 3D image and of achieving a good 3D image after the initial alignment. However the structure is very complicated and the multiple lenticular film structure is of less cost effectiveness.
3. Electronic compensation of the alignment error involves many mathematical calculations which are impractical.

In a word, the traditional direct-view lenticular 3D display has many limitations in its applications.

### SUMMARY OF THE INVENTION

It is the primary objective of the present invention to realize readjustable and fine-tunable lenticular 3D LCD TV and monitor.

It is another objective of the present invention to use a rigid lenticular structure to realize mechanical stability.

It is again another objective of the present invention to use air gap between the lenticular structure and the display panel.

It is other objective of the present invention to use a mechanical adjusting mechanism to position the lenticular film in the X, Y and Z directions.

It is another objective of the present invention to use a standard alignment 3D image during the mechanical adjusting process.

It is again other objective of the present invention to design a lenticular structure which is face down to the display panel and the flat surface to face up to the viewer.

It is another objective of the present invention to design a normal mode lenticular structure which is of lenticular structure face up to the viewer while the flat surface face down to the display panel but separated by an air gap.

It is another objective to design a 3D system to realize a real time video capture and display net work structure.

### BRIEF DESCRIPTION OF THE DRAWINGS

FIG. 1 demonstrates a schematic drawing of the prior art lenticular 3D display structure.

FIG. 2 demonstrates a schematic drawing of a normal mode 3D display structure of the present invention.

FIG. 3 demonstrates a schematic drawing of a reverse mode 3D display structure of the present invention.

FIG. 4a demonstrates a schematic drawing of lenticular film lamination process of the present invention.

FIG. 4b demonstrates a schematic drawing of lenticular film curing process of the present invention.

FIG. 4c demonstrates a schematic drawing of lenticular film registration process of the present invention.

FIG. 4d demonstrates a schematic drawing of lenticular film fixing process of the present invention.

### DETAILED DESCRIPTION

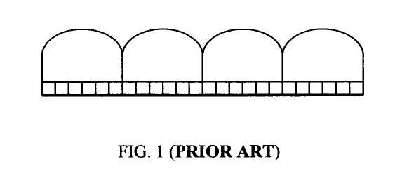

Referring first to FIG. 1, illustrated is a schematic drawing of the prior art lenticular display structure. The lenticular 3D LCDs are utilizing a flexible lenticular film laminated permanently on the display panel by means of a pressure sensitive adhesive layer after an initial registration during the manufacturing process. Once the film has attached on the front surface of the display it is impossible to fine-tuning the 3D effect for achieving the maximum accuracy. Misalignment is the major problem of the products. The flexible film is provided with lens elements that are cylindrical lenses with a circular cross section. The lenticular film consists of a transparent plastic substrate with multiple convex lenses formed on a viewer side. The backside of the film or flat side is considered a non-viewer side which is directly attached onto the display front surface. For 3D images the viewing angle is inversely proportional to the amount of virtual depth that can e created with a lenticular lens. A larger viewing angle will provide less virtual depth and a smaller viewing angle will provide more virtual depth. Virtual depth is defined as the perceived distance either into or out of the viewing plane.

In the lenticular lens, an array of cylindrical lenses direct light from alternate pixel columns to a defined viewing zone, allowing each eye to received a different image at an optimum distance. This method provides a restrictive view but it would be possible to view an image continuously across the viewing zones if eye tracking technology is used. Once the users eye passes form one image band into another the image would usually invert, however if the images shown to each side of the zone are flipped once the eye passes it is possible to create a continuous image.

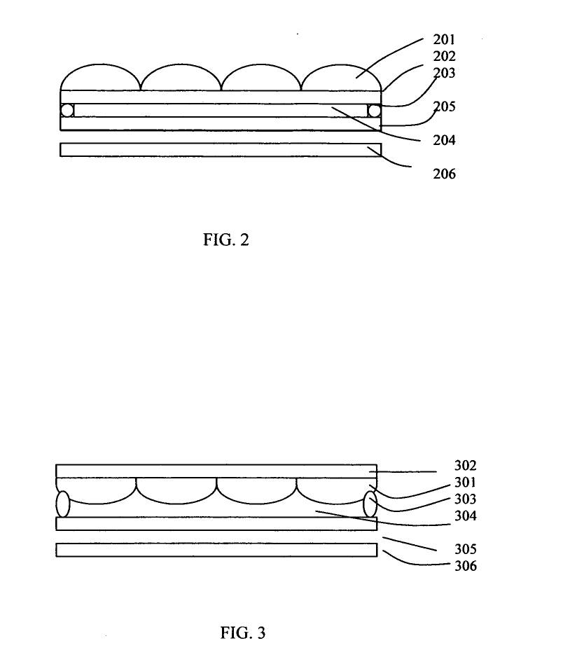

Turning now to FIG. 2, illustrated is a schematic normal mode lenticular 3D display structure of the present invention. The lenticular film 201 is pre-laminated with a rigid substrate 202 made of either glass or plastic plate. For example, a panel of 3 mm temper glass can be used for the lamination. The rigid lenticular structure and the TFT display panel 205 can be separated by a spacing structure 203 with air gap 204. The back panel 206 represents all those rest parts of the display including back cover, master electric board, I/O ports, backlit panel and so on.

There are some extraordinary advantages compared with the prior art:
1. The Rigid Lenticular Structure
The novel structure maintains the mechanical dimensions of the lenticular structure even in a harsh temperature environment.
2. Alignment Accuracy
The alignment between the lenticular substrate and the TFT display panel, during the manufacturing process, can be precisely controlled which eliminate the alignment error of pixel-to-pixel registration in the prior art.
3. End User Fine-Tuning
The novel rigid lenticular structure allows an end user fine-tuning his/her 3D TV or monitor to achieve the maximum 3 dimensional function with an optimal viewing angle based on their own judgments.
4. High Production Yield
The air gap between the lenticular panel and the display panel allow the production with very high yield which eliminate the possibility of involvement of the dust due to the static charge and cleanness issue of the clean room.
5. Re-Workable
In case of one of the panel, either the lenticular structure or the display panel has a defect or being damaged, the failed part can be easily replaced.

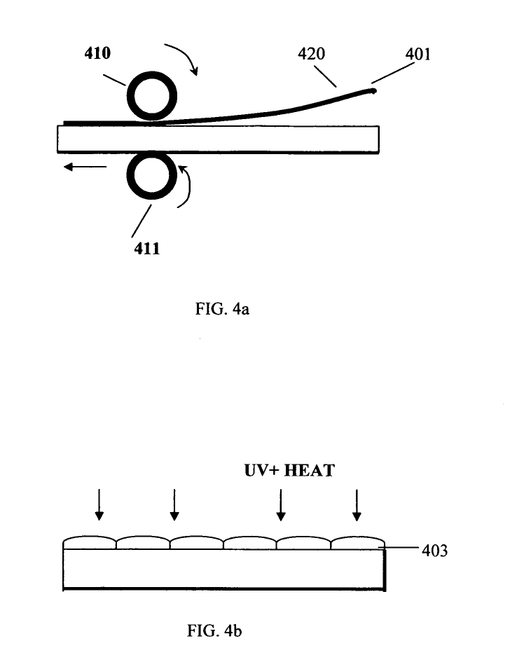

Turning now to FIG. 3, illustrated is a schematic reverse mode lenticular 3D display structure of the present invention. The lenticular film 201 is pre-laminated with a rigid substrate 202 made of either glass or plastic plate. For example, a panel of 3 mm temper glass can be used for the lamination. The rigid lenticular structure and the TFT display panel 205 can be separated by a spacing structure 303 with air gap 304. The back panel 206 represents all those rest parts of the display including back cover, master electric board, I/O ports, backlit panel and so on. The difference between FIG. 3 and FIG. 2 is that the former has a big air gap and the lenticular surface is facing down to the display surface.

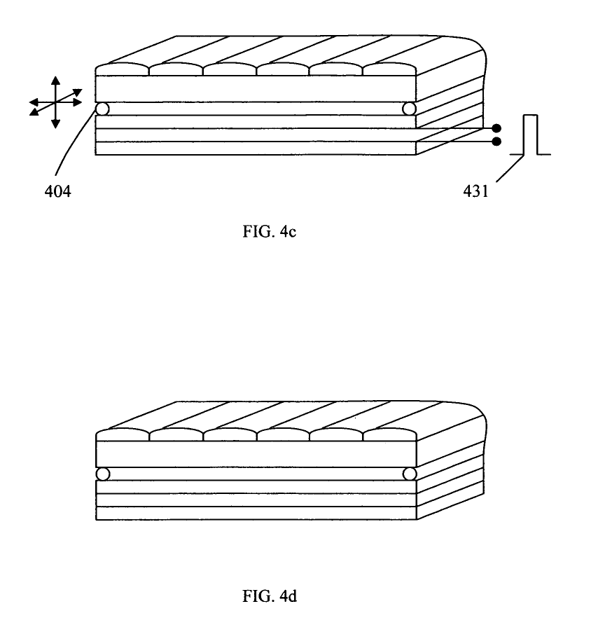

Turning now to FIG. 4, illustrated is a schematic drawing of manufacturing process of the present invention. FIG. 4a demonstrates a laminating process. A UV curable pre-polymer mixture 420 is made of polyacrylic pre-polymer, monomer, polymeric spacer, UV initiator and so on. The viscosity of the mixture is adjusted in the range of 300-500CP. The optimal percentage of the spacer material is in the range of 0.15˜0.2%.

A laminator 410 carries out the application of pre-polymer mixture. A pair of nip rubber rollers 411 is designed with durability of 45˜50 and adjustable gap control mechanism. The laminator also has a registration and speed control system. The mixture 420 is applied on the front edge of glass substrate by a linear moving dispenser. The lenticular film 401 is laid on the top of pre-polymer material while moving through the rubber nip of the laminator 410. The pre-polymer mixture is spread out between the two substrates with the thickness determined by the spacer. The lenticular panel is larger in the displayable area than that of the display panel, so there will be no leakage of the pre-polymer material back to the lenticular surface.

The UV curable pre-polymer can be also used as the in-situ lenticular structure formulation wherein it is coated on top of the film by means of the coating head. After the initial polymerization by an instant UV exposure, the sticky coating layer will pass through the engraved lenticular Chrome roller attached on the laminator 410 and followed by a post-cure in the following step.

FIG. 4b demonstrates a film relaxation and UV curing process. The sandwiched structure produced in FIG. 4a is then placed in an oven at 60C for two hours and let the lenticular film fully relaxed and stress during the lamination is substantially eliminated. And then the lamination sandwich is positioned underneath of an UV exposure machine. As the temperature reaches room temperature, the UV exposure machine will be turned “on” and started to expose the lenticular structure.

FIG. 4c demonstrates a registration and alignment process. The UV cured lenticular structure is positioned on the top of the TFT display panel by means of vacuum pick-and-placement mechanism. A predetermined spacing structure 404 is deposited on the fore corners and fore sides of the non-display area of the display panel. A CCD sensor and X.Y.θ table may be placed underneath of the display panel. Once the TFT display is addressed by a standard signal generator with a standard waveform 431 and a 3D image is displayed on the LCD screen, the registration and alignment between the lenticular plate and the display panel will be carried out. A pressure is needed to press the two panels to ensure a uniform air gap while the X.Y.θ table is kept moving along a set of registration marks until alignment is completed. The registration process can be also carried out by a semi-automatic or even a manual operation under a microscope.

FIG. 4d demonstrates a final fixing step

After a dynamic registration and alignment, the 3D display comes to a fixing stage wherein a slant UV light is utilized to cure the spacer permanently. Meanwhile a mechanic fixture may be designed to further fix the positions of the assembly. The fixture consists of three-pin registration system, wherein two pins are designed in horizontal direction and the other pin is in vertical direction along the edge of the display panel. Conventionally, for most important applications such as televisions and computer monitors, it is recognized that maximizing performance for horizontal viewing directions is more important than maximizing performance for vertical viewing directions. For example, for TV applications, multiple viewers of a display device will normally be arranged with their eye levels more-or-less consistent relative to the screen (i.e., with very little variation along the Y-axis), but their horizontal viewing angles relative to the X-axis may vary significantly. Similarly, a user seated at a computer monitor is more likely to vary head position along the X-axis while working, than along the Y-axis. Two pins along the edge of the horizontal direction will ensure the fine-tuning the lenticular panel relative to the display panel be achieve the optimal viewing result.

Needless to say that both the normal mode and reverse mode lenticular 3D displays can be manufactured by the above-mentioned process. And FIG. 4 is only a typical process to realize the target product of the present invention. Other production process may be introduced without departure the principle of the present invention and within the scope of the spirit of the present invention.

We claim:

1. An adjustable direct-view lenticular 3D LCD device comprising:
a. a display panel with at least one angular position;
b. a rigid lenticular panel;
c. a spacer structure;
d. an air gap
wherein the rigid lenticular panel and the display panel positioned with an air gap and a predetermined X, Y, θ allows the display panel at an optimal focal plane of the lenticular panel;
wherein the rigid lenticular panel ensures the maximum lens uniformity and mechanical stability to turn out perfect alignment with predetermined LCD pixels;
whereby the adjustable lenticular 3D LCD device allows a user to discern an optimal 3D images.

2. The adjustable lenticular 3D LCD device as in claim 1 wherein the display panel is a full color transmissive active matrix liquid crystal display.

3. The adjustable lenticular 3D LCD device as in claim 1 wherein the rigid lenticular panel is composition layer made of a lenticular film and a temper glass.

4. The adjustable lenticular 3D LCD device as in claim 1 wherein the rigid lenticular panel is a composition layer made of a lenticular film and a plastic plate.

5. The adjustable lenticular 3D LCD device as in claim 1 wherein the spacer is of an elastic adjustable structure.

6. The adjustable lenticular 3D LCD device as in claim 1 is a direct-view portable electronic device.

7. The adjustable lenticular 3D LCD device as in claim 1 wherein the pixels of the display panel has an optimal X, Y and θ positions with the lenticular panel.

8. The adjustable lenticular 3D LCD device as in claim 1 wherein the lenticular panel is of normal mode lenticular structure with the lens face up to a viewer.

9. The adjustable lenticular 3D LCD device as in claim 1 wherein the lenticular panel is of reverse mode lenticular structure with the lens face down to the display panel.

10. An adjustable direct-view lenticular 3D LCD device manufacturing process comprising:
a. a rigid lenticular panel lamination process;
b. a spacer structure deposition process;
c. a vacuum holding and X, Y, θ registration process;
d. a fixing process;
wherein the lenticular panel is larger in it displayable area than that of the display panel and the lenticular structure is be either face up to the viewer or face down to the display panel;
wherein the registration process is dynamically controlled by a 3D standard image from the display panel;
wherein the fixing process including polymerization and mechanical system;
whereby the adjustable lenticular 3D LCD manufacturing process produces a superior 3D LCD device which allows a user to discern an optimal 3D images.

11. The An adjustable lenticular 3D LCD device manufacturing process as in claim 10 further including a lenticular structure in-situ manufacturing process.

12. The adjustable lenticular 3D LCD device manufacturing process as in claim 10 wherein the rigid lenticular panel is formulated by a UV curable polyacrylic material.

13. The adjustable lenticular 3D LCD device manufacturing process as in claim 10 wherein the 3D structure is a normal mode lenticular structure with its lens face up to the viewer.

14. The adjustable lenticular 3D LCD device manufacturing process as in claim 10 wherein the 3D structure is a reverse mode lenticular structure with its lens face down to the LCD panel.

15. The adjustable lenticular 3D LCD device manufacturing process as in claim 10 wherein the spacer structure ensures the display pixels with the optimal angular and coordinate positions relative to the lenticular panel.

16. The adjustable lenticular 3D LCD device manufacturing process as in claim 10 wherein the mechanical structure ensure the display with the optimal 3D images.

17. The adjustable lenticular 3D LCD device manufacturing process as in claim 16 wherein the mechanical structure including three-pin system wherein two pin along the X-axis and other pin along the Y-axis.

18. The adjustable lenticular 3D LCD device manufacturing process as in claim 16 wherein the mechanical structure ensure the display with the optimal 3D images in the horizontal direction.

19. The adjustable lenticular 3D LCD device manufacturing process as in claim 10 wherein the mechanical structure allows the user to fine-tune the display for the optimal 3D images.

20. The adjustable lenticular 3D LCD device manufacturing process as in claim 10 wherein the mechanical structure ensure the display with the optimal 3D images.
